(19) United States
(12) Patent Application Publication
(10) Pub. No.: US 2009/0034077 A1
(43) Pub. Date: Feb. 5, 2009

(54) Grating with angled output prism face for providing wavelength-dependent group delay

(75) Inventor: Steve J. Kane, Bridgewater, NJ (US)

Correspondence Address: BROWN RUDNICK LLP, ONE FINANCIAL CENTER, BOSTON, MA, 02111, US

(73) Assignee: HORIBA Jobin Yvon, Inc.

(21) Appl. No.: 11/888,753

(22) Filed: Aug. 1, 2007

(51) Int. Cl. G02B 5/18; G02B 27/44; H01S 3/00

(52) U.S. Cl. 359/566; 359/333; 359/572

(57) ABSTRACT

A method and apparatus for dispersion compensation which provides a specified, well-controlled, wavelength-dependent optical path length in a laser or other optical system. A reflection grism-like device with an angled output interface is designed to simultaneously provide negative GVD and negative TOD, and therefore can be used to compensate for material dispersion. These gratings are very efficient due to their near-Littrow configuration and can be used over a broad spectral range, which is particularly useful in ultra-short-pulse applications.

### FIELD OF THE INVENTION

The present invention relates to optical devices incorporating gratings and prisms and is applicable to the field of laser systems, particularly dispersion compensation in pulsed laser systems.

### BACKGROUND OF THE INVENTION

Many industrial and scientific applications require the production of relatively high power and very short pulses of light, with durations of picoseconds down to several femtoseconds. As a general rule, a short pulse of optical energy can only be produced and maintained under two conditions. First, a broad spectrum of frequencies is present in the pulse. In other words, rather than producing a monochromatic, ultrashort pulse, as the pulse duration becomes shorter, the pulse tends to become more and more polychromatic, having different wavelengths and corresponding different frequencies. Light at all of these frequencies best arrives at the destination in phase. For this to happen, each frequency should travel the same optical path length). If the frequencies (i.e. wavelengths) in a pulse of optical energy do not travel the same optical path length, the pulse will become temporally broadened and/or distorted.

Whether different wavelengths travel over the same optical path length in a particular material depends upon the characteristic of the material through which they are propagating. Transparent materials (glass, crystals, etc.) have the property of imparting a wavelength-dependent phase which is well-characterized by the index of refraction of the material. In nearly all common optical materials, for the spectral range extending from the ultraviolet to the near-infrared, the mathematical relationship which determines the phase has the same functional form. There is a variation which is quadratic with frequency, and a variation which is cubic with frequency. The quadratic phase is commonly called Group Velocity Dispersion, or GVD, and it is positive in sign (i.e., the optical path length increases with increasing frequency) for common transparent materials, and the cubic phase is commonly called Third-Order Dispersion, or TOD. TOD is also positive in sign for common materials.

### SUMMARY OF THE INVENTION

This characteristic of transparent materials and their tendency to cause a pulse to become temporally broadened and/or distorted may be used to advantage in the case of the generation of ultrashort high-power pulses of optical, for example laser, energy. Generally, such systems operate by raising the energy level of the atoms in the laser medium. A relatively short trigger or seed pulse is then sent into the laser medium, causing the atoms to drop to a lower energy state in response to the triggering photons in the short trigger pulse. The result is the release of photons corresponding to the drop in energy state for each atom and a resultant relatively much higher power pulse. The problem which this creates is potential damage to the laser due to overheating or other physical phenomena.

This problem is addressed by using an optical stretcher which utilizes the group velocity dispersion and third order dispersion phenomena discussed above to temporally stretch out the pulse, thus lowering its peak energy and preventing damage to the laser. In principle, this may be done by a factor as large as on the order of 10,000. This is achieved by passing a short optical pulse through a dispersive delay line having a given group velocity dispersion and third order dispersion characteristic. The output of the laser is then passed to an output coupling element or elements which act as a pulse compressor.

Pulse compressors ideally have the opposite group velocity dispersion and third order dispersion characteristic of the pulse stretcher. The objective is to null out the distortion of the original short pulse by introducing characteristics equal in magnitude but opposite in sign to the characteristics of the distortion to which the original short optical pulse had been subjected. The result is a laser pulse at the output of the output coupling element with a temporal characteristic matching the input seed pulse, but delayed in time. In principle, very high power short pulses of optical energy may be produced using this technique.

The need to compensate for GVD and TOD of materials, by devising an optical system whose GVD and TOD are, ideally, equal and opposite to that of the material in the system, has led to the development of prism-pair and grating-pair compressors. Owing to the frequency-dependent path lengths in the grating pair and prism pair, it is possible to construct systems whose GVD can compensate for the GVD of materials. Grating-pair and prism-pair compressors are ubiquitous in the field of short-pulse lasers.

As can be understood from the above discussion, prism-pair compressors rely on the wavelength-dispersive property of the glass material of which they are made to angularly disperse a spectrum of light, and each frequency travels a different distance between the pair. Prism pairs can be constructed to have the desired negative-GVD and negative-TOD. However, the physical size of a prism compressor is quite large and not practical in many circumstances. Typically, each centimeter of dispersive material in the system must be compensated by a prism pair which is about a half meter long. In a typical system, a considerable amount of laboratory space must be dedicated to compensating a very small amount of material GVD.

Grating-pair compressors, which are more compact, rely on a wavelength-dependent diffraction angle to angularly disperse a spectrum of light, in a manner similar to a prism compressor. The grating dispersion is much stronger than that of a prism, and therefore a grating compressor can be much more compact. However, as has been shown by Kane and Squier in 1995, a grating compressor can generally be configured to have negative GVD, but not negative TOD. Therefore, the TOD of a grating pair does not compensate for the TOD of material. Most critically, and to the contrary it adds to the TOD of the material. When a pulse travels through dispersive material and then through a grating-pair compressor, the GVD can be removed but the leftover TOD results in a broadened and asymmetrically-distorted pulse shape.

As was alluded to above, one of the problems in generating short-pulse laser optical energy is how to create a very short, very intense, very high energy pulse, that does not destroy or damage the very amplifiers which are creating it. This problem was solved in 1983 by Strickland et al., using the technique of chirped-pulse amplification (CPA).

In accordance with the CPA technique, briefly described above, a low-energy short pulse is intentionally sent through a dispersive medium (such as optical material or optical fiber known as a fiber stretcher) whose positive GVD broadens the pulse duration by a factor of 100-10,000. This ‘stretched’ pulse is sent to the amplifier, where it extracts energy and grows in strength. Though it now has high energy, its long duration keeps the peak intensity to a safe level, and the amplification is performed without any damage to the amplifier.

When the pulse is fully amplified, it is ejected from the amplifier and sent to an external dispersive system for compression with the objective of negativing out the dispersion (introduced using the dispersive medium with the object of protecting the laser source from intolerably high peak powers). As alluded to above, a grating pair is the most commonly-used compressor because of the size of prism pair compressors. Interestingly, however, because the grating pair cannot compensate for the TOD of the dispersive stretcher, this fiber-stretcher-grating-compressor system was nearly abandoned in the early 1980's. Instead, the fiber stretcher was replaced by a modified grating stretcher, as taught by Pessot et al. in 1985. The modified grating stretcher exhibits positive GVD and negative TOD, and therefore is a better match to the grating-pair compressor.

There are still many systems, however, which do not utilize the complex grating-pair stretcher, and instead choose to use a more-simple refractive material stretcher and simply accept the uncompensated TOD. The result is quite a substantial negative impact on the performance of such systems. For example, the commercially-available RegA™ amplifier from Coherent, Inc., might be capable of producing 50 fs pulses, if it had full TOD compensation, but because the system uses a standard grating pair, the specifications for the laser are listed at 150 fs pulse duration.

As disclosed in United States Patent Application No. US2004/0000942 A1 of Kapteyn et al., a new class of lasers based on downchirped-pulse amplification (DPA) stretch an initial seed pulse using a complicated sequence of gratings and prisms to provide both negative GVD and negative TOD. The pulse is then amplified, optionally spatially expanded, and sent through a compressor, such as a block of glass with positive GVD and positive TOD for compression. The advantage of this system is that the bulk-glass compressor throughput is extremely high, approaching 95%, compared with a traditional grating-pair compressor throughput of 50-60%. However, the grating pair and subsequent prism-pair stretcher are very difficult to align, far too complex for a commercial system and the prism pair takes up nearly 1.5 meters of table space.

The inventive system provides a solution to this problem. Moreover, the inventive system may be utilized in other applications. For example, in other areas of optics, it is often desirable to use a fiber delivery system to transport an optical signal from a source to its destination. Fibers are an ideal medium for guiding light, but their GVD and TOD will distort short pulses which propagate through them. To maintain a short pulse on target, it is necessary to compensate GVD and TOD in the optical pulse or signal output by the fiber, or to pre-compensate the GVD and TOD before the pulse enters the fiber.

Finally, the production of short pulses requires a very complicated interplay between dispersion and gain (amplification). It has been shown that in fiber lasers, the shortest pulses are produced when the GVD and TOD of the laser itself is minimized. To minimize GVD and TOD, it may be desirable to include some dispersion-compensating material inside the laser cavity which has negative GVD and negative TOD.

Kane and Squier showed in 1994 that a pair of grisms (e.g., a transmission grating coupled to a prism and having an output face parallel to the grating (also known as a carpenter prism) could be used to create a dispersive delay line with negative GVD and negative TOD. This was demonstrated in 1994, by stretching a short pulse with 100 meters of fiber, amplifying, and compressing it to its original duration.

These transmission grisms were in a traditional Carpenter prism configuration wherein a plano grating was coupled to a prism, and the prism was used as the input aperture. Tournois has shown that the condition for negative TOD could be satisfied with a Carpenter prism when the grating was utilized in a far-from-Littrow configuration (i.e., the input ray and the exit rays have a large deviation angle between them). However, diffraction gratings have high efficiency when used at or near the Littrow configuration, but the equations governing dispersion of a Carpenter prism show that for GVD and TOD compensation of materials, a grism pair should be used in a substantially off-Littrow configuration. Because of the low efficiency of these components, grisms were not seriously considered as a practical solution to the problem of GVD/TOD compensation.

Another difficulty with the Carpenter prism, in addition to low efficiency, is that the constraint of off-Littrow operation requires the grating to be used at very steep incidence angles inside the glass. It is well known that when light impinges on a glass-air interface at an angle from within the glass, there is a ‘critical angle’ beyond which there is no transmission through the interface. In this situation virtually all of the light reflects off the interface which acts like a mirror. To solve this problem, all glass-air interfaces between the prism and the grating are eliminated. This is done by cementing the grating with a transparent glue directly to the face of the prism. While this eliminates the problem of total internal reflection, the requirement of using a cemented grating creates problems for grating efficiency, introduces multiple diffraction orders, and limits the optical power which can be incident on the grism (as the cement interface tends to burn prematurely compared to the prism or the grating).

Others have attempted to solve the problem by using a sequence of prisms following a conventional diffraction grating pair (Backus, 2005), or by embedding a pair of prisms between two diffraction gratings (Kane, 1994, and Buckley, 2006). Active devices including acousto-optic modulators (available from Fastlite SAS), pulse shapers (available from Coherent, Inc.) and static devices including “chirped” mirrors (Baum, 2006) have been explored with limited success.

Embodiments of the present invention provide a method and apparatus for dispersion compensation which provides a specified, well-controlled, wavelength-dependent optical path length in a laser or other optical system.

Embodiments of the invention disclosed herein provide a new class of gratings comprising grisms incorporating gratings, for example reflection gratings, with an angled output interface. These devices can be designed to simultaneously provide negative GVD and negative TOD, and therefore can be used to compensate for material dispersion. These gratings are very efficient owing to their near-Littrow usage and can be used over a broad spectral range, which is critical for ultra-short-pulse applications. Moreover, the required alignment is not so critical as to make commercial manufacture impractical. Finally, the inventive system achieves these objectives in a reasonably-sized system.

A compressor with negative GVD and negative TOD designed according to illustrative embodiments of the invention can provide a factor-of-three improvement in pulse duration and pulse intensity in a system comparable to commercially available products, such as the RegA™ amplifier.

As appears more fully below, one illustrative embodiment of the invention provides a compensating grism-like device including an entrance refractive optic such as a prism having an entrance surface and a grating interface surface, an exit prism having a grating interface surface and an exit surface; and a transmission grating disposed between the first prism grating interface surface and the second prism grating interface surface. The exit surface is not parallel to the transmission grating. The illustrative embodiment provides negative group velocity dispersion and negative third order dispersion of light transmitted through the grism. The illustrative embodiment can be implemented in such a manner that the light has an angle of incidence with said grating that is approximately equal to an angle of refraction from the grating (i.e., near Littrow).

In the illustrative embodiments, the grating can have between about 300 lines per millimeter and about 2000 lines per millimeter. The light is incident with the grating at an angle below a critical angle of the prism material such that total internal reflection of light does not occur at a prism-grating interface.

Another illustrative embodiment of the invention provides a compensating grism-like device including a prism having a first surface and a grating interface surface and a reflection grating disposed against the grating interface surface such that light traveling through the prism and incident to the grating reflects from the grating back into the grating interface surface. The light after reflecting from the grating exits from the prism through a surface that is non-parallel to the reflection grating to provide negative GVD and negative TOD of light transmitted through said grism.

In one implementation of this embodiment, the first surface provides both an entrance surface for the light and the exit surface that is non-parallel with the grating. In another implementation of this embodiment, the first surface provides an entrance surface for the light and the prism includes a second surface which provides an exit surface that is non-parallel with the grating. The characteristics of the grating, the prism and the orientation of the system may vary widely. For example, in a particular embodiment, the grating can have about 600 lines per millimeter and be used with light having a wavelength of about 800 nanometers. In another exemplary embodiment, the grating can have about 1480 lines per millimeter for use with light having a wavelength of about 1030 nanometers.

Another illustrative embodiment of the invention provides a method of making a compensating grism by selecting a prism-grating pair having parameters which yield a pre-determined TOD/GVD ratio and fixing the grating to a first prism surface of the prism such that an exit surface of the prism is not parallel to the grating. In one implementation of this embodiment, the grating can be cemented to the first surface, for example. In another implementation of this embodiment, the grating can be mechanically fixed to the first prism surface.

Another illustrative embodiment of the invention provides a method for making a short, high energy, high intensity laser pulse by sending a low energy pulse through a dispersive medium having a positive GVD and a positive TOD to broaden the pulse by a factor of about between 100-10,000, sending the broadened pulse to an amplifier wherein the amplifier adds energy to the broadened pulse, ejecting the amplified pulse from the amplifier; and applying the amplified pulse to an external compression grism having negative GVD and negative TOD at near Littrow angles of incidence.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a schematic diagram of a Carpenter prism-grating according to the prior art;

FIG. 2 is a schematic diagram of a compensating grism-like device having an entrance prism and an exit prism fixed with relation to a transmission grating disposed therebetween according to an illustrative embodiment of the present invention;

FIG. 3 is a schematic diagram showing an additional different embodiment of the present invention comprising a reflection grism-like device which employs a common prism surface for input and output;

FIG. 4 is a schematic diagram showing yet another embodiment of the present invention comprising a reflection grism-like device which employs a common prism surface for input and output, but incorporating an air gap;

FIG. 5 is a schematic diagram showing still another embodiment of the present invention comprising a reflection grism-like device which employs different surfaces of a common prism for input and output;

FIG. 6 is a functional block diagram of a method for producing a compression grism-like device according to illustrative embodiments of the present invention;

FIG. 7 is a block diagram of a system for producing a high-powered ultra-short laser pulse according to illustrative embodiments of the present invention; and

FIG. 8 is a block diagram of a communications system according to an illustrative embodiments of the present invention.

### DETAILED DESCRIPTION

The Carpenter-prism design, as shown in FIG. 1, has a limited number of parameters which can be used to affect the GVD and TOD imparted to light passing through the device. These parameters include the prism refractive index, the geometry of the prism 10, the groove density of the grating 12, and the incidence angle 14 on the grating. Generally, such devices comprise a prism 10 secured to a linear, for example ruled, planar grating 12 by a quantity of transparent cement 15. Light 16 entering the system passes through cement 15, and exits through surface 17, which is parallel to the ruled surface 18 of grating 12.

In contrast, illustrative embodiments of the present invention provide a grism-like design (for convenient reference sometimes referred to herein as a “grism” because it does include a grating and one or two prisms) which allows for the incidence angle on a grating within a grism-like device to be a more freely selectable design parameter as compared to a Carpenter prism or grism configuration. Moreover, in accordance with one particularly preferred embodiment of the invention, designs may be achieved using off-the-shelf gratings designed for use in air. In illustrative embodiments of the present invention an exit surface which is not parallel to the grating is provided by coupling a second prism to the grating which acts as the output surface.

It is noted that while the term “prism” may be used herein, the same is meant to encompass a refractive member of any appropriate shape configured to perform the functions of the devices of the present invention by providing dispersion compensation in connection with a grating that is not parallel to the output face of that refractive member or which is configured in Littrow.

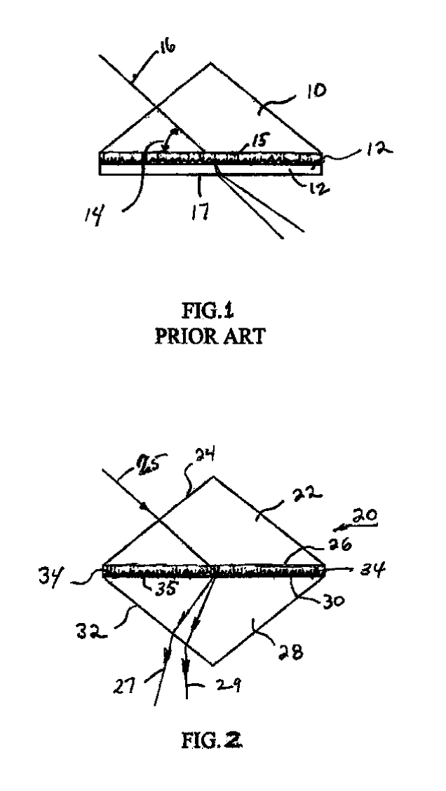

FIG. 2 shows an example of such a compensating grism-like device 20 constructed in accordance with the present invention. Compensating grism-like device 20 has an entrance prism 22 with an entrance surface 24 and a prism-grating interface surface 26. An exit prism 28 has a grating-prism interface surface 30 and an exit surface 32. Transparent optical cement may be used at interfaces 26 and 30. As can be seen with reference to FIG. 2, the addition of a second prism 28 results in provision of an exit surface 32 which is not parallel to the transmission grating 34 disposed between the entrance prism 22 and the exit prism 28. In accordance with the preferred embodiment, creating 34 has linear parallel equally space grooves 35. Grooves 35 defined and a plane. The orientation of non-parallel exit surface 32 can be selected to allow for GVD and TOD compensation with a grating incidence-angle very near Littrow. In principle, it is also possible to vary the indices of refraction of both prisms 22 and 28. These additional design parameters, as compared to a Carpenter prism, allow the illustrative embodiment to overcome the failure of prior art to provide highly efficient operation in a simple easy to implement, use and maintain design.

As is noted above, the use of a conventional grism or Carpenter prism suffers from the necessity of having to have a relatively large angle between the input light path and the output light path. This is addressed in accordance with the present invention by implementing a design which provides for an exit light path that passes through and output face of a prism, where the output face is not parallel to the grating. This can be achieved, for example, through the use of an additional refractive optical member, such as a prism, or by redirecting the path of light through the inventive grism-like device, for example by using a reflective grating.

It is noted that grating 34 may be oriented with grooves facing either entrance prism 22 or exit prism 28. The differences in path lengths and the other characteristics of the system result in imparting both negative TOD and negative GVD. Likewise, a wide range of groove densities in the planar linear grating may be used to own with higher groove densities resulting in greater deflection of a diffracted light 27 and 29 to the left in FIG. 2.

In this system, a pulse of light 25 entering device 20 passes through transmission grating 34 which separates light 25 into longer wavelengths 27 and shorter wavelengths 29.

By choosing common pulse compression gratings (with line densities between 600 and 2000 lines/mm), the extra design parameters provided by the new configuration make it possible to employ a grating near Littrow, at an incidence angle which is well above the critical angle of the glass of which prism 22 is made. Therefore, there is no longer a total-internal reflection problem at prism/grating interface 26, and the requirement of having a cemented interface no longer applies.

In accordance with the present invention, it is contemplated that device designed will be done using conventional ray tracing techniques. More particularly, the various parameters in the system are selected on the basis of an intuitively derived design or a known best match design, and then parameters are incrementally varied, optical characteristics calculated and all the designs evaluated for great numbers of designs, in a brute force approach taking advantage of available very substantial computer power today. For example, one may begin by selecting an input angle likely to result in an angle with respect to the diffraction grating which is substantially larger than the critical angle, select known glasses or commercially available compression gratings and prisms, and then evaluate the performance of the system and then try alternate designs using other available prisms and gratings in various combinations and comparing results to optimize the design with, for example, commercially available prisms and gratings. On the other hand, where higher performance is needed, customization, for example varying the angle of the prism, or the like may be used in a selective variation sequence to further optimize a design. Optionally, further parameters may be varied, for example the line density of the grating. Even further possibilities involve return to already optimized parameters to further refine the design given changes in later optimized parameters, and so forth, using other techniques used in other ray tracing problems.

The equations for calculating TOD and GVD in prism/diffraction grating systems are well-known and are described in G. Reid and K. Wynne, “Ultrafast Laser Technology and Spectroscopy,” Encyclopedia of Analytical Chemistry (R. Meyers (Ed.)).

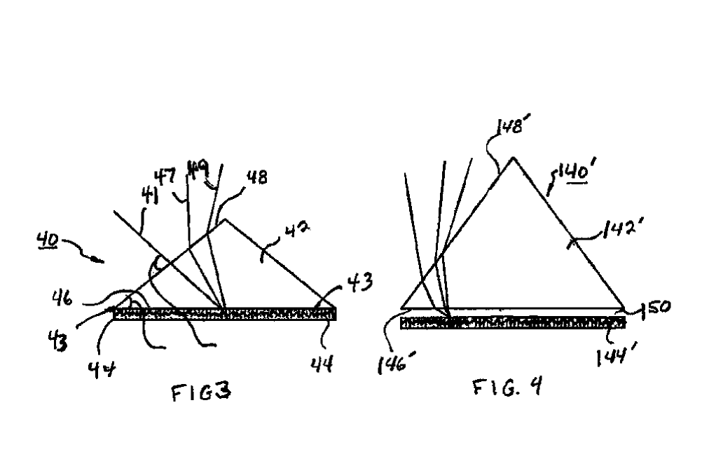

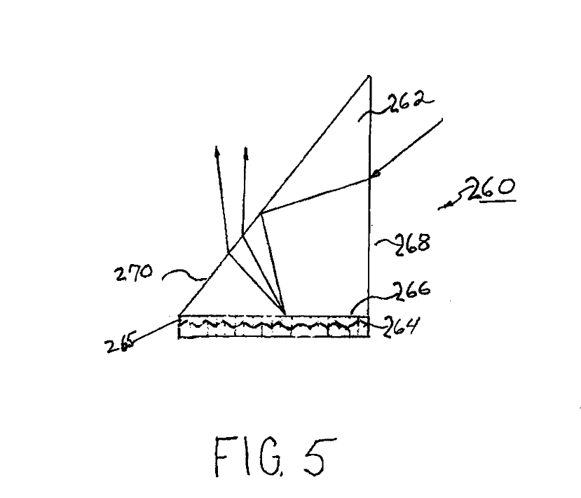

The present invention is not limited to being configured using a transmission grating, as described above in connection with FIG. 2. Reflection gratings can be used instead of transmission gratings and the system configured to have a non-parallel exit surface (and thus most of the additional design parameters) according to alternative embodiments of the present invention, as described with reference to FIG. 3 and FIG. 4.

More particularly, FIG. 3 shows an embodiment of the present invention comprising a reflection grism-like device 40. Device 40 employs a common prism 42 as an input prism for light 41. Prism 42 has a prism angle α. A linear equispaced planar ruled grating 44 replaces the transmission grating of the embodiment of FIG. 2. This results in substantial improvements in efficiency. Generally, reflective gratings are substantially more efficient than transmission gratings. This efficiency is important to the system and is particularly important in measuring low light levels and other difficult tasks. Moreover, in accordance with the preferred embodiment of the invention, ruled gratings are preferred, although holographically manufactured gratings may also be use. More particularly, in accordance with the present invention it is contemplated that grating 44 may be a grating replicated from a mechanically ruled grating. While, in principle, the use of an original ruled gratings will improve the quality of the system, such gratings are relatively expensive and not practical for the majority of applications. Alternatively, a holographic original or a holographically made replica grating will also function at additional savings.

Reflection grating 44 is cemented to prism 42 at grating interface surface 46 using a transparent optical cement 43. Prism 42 has a first surface 48 which not only acts as an entrance surface, but also functions as an exit surface that is not parallel to grating 44, allowing the design of a system configured near Littrow in a manner similar to that of the embodiment of FIG. 2. Light 41 entering grism-like device 40 is separated into longer wavelengths 47 and shorter wavelengths 49, by diffraction at grating 44 as a result of the incidence of input light 41 at an angle β with respect to the normal 45 to the grating 44. As alluded to above, the end result is a highly efficient and easy to construct device which imparts negative TOD and negative GVD.

One particularly advantageous embodiment of the invention is illustrated in FIG. 4. More particularly, FIG. 4 (with corresponding elements numbered 100 higher than analogous elements in the FIG. 3 embodiment) shows an alternative embodiment of the present invention comprising grism-like device 140 which employs a prism 142 for input and output wherein an air space interface gap 150 is disposed between the prism 142 and a reflection grating 144. Reflection grating 144 is in facing spaced relationship to the grating interface surface 146 of prism 142. Prism 142 has a surface 148 which acts as an entrance surface. Surface 148 also access and an exit surface that is not parallel to the grating 144.

By separating the grating and the prism, as illustrated in FIG. 4, several benefits are realized. First, there is no danger of burning an epoxy or other optical cement interface, so the inventive grism-like device can be used with high-power lasers. Second, the gratings can be made much more efficient, as fewer diffracted orders will exist as a result of the absence of the cement layer. And third, the designer can take advantage of a wide variety of gratings which already exist in the marketplace and have been designed to work with an air interface.

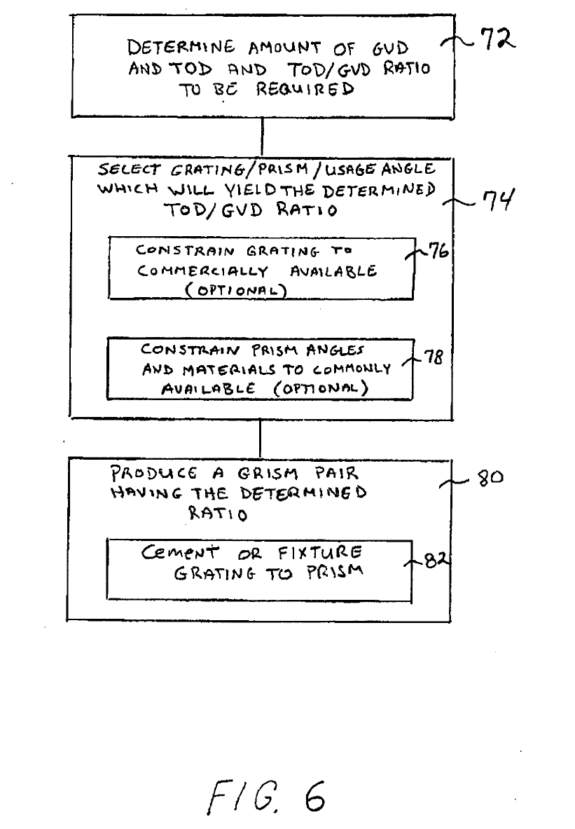

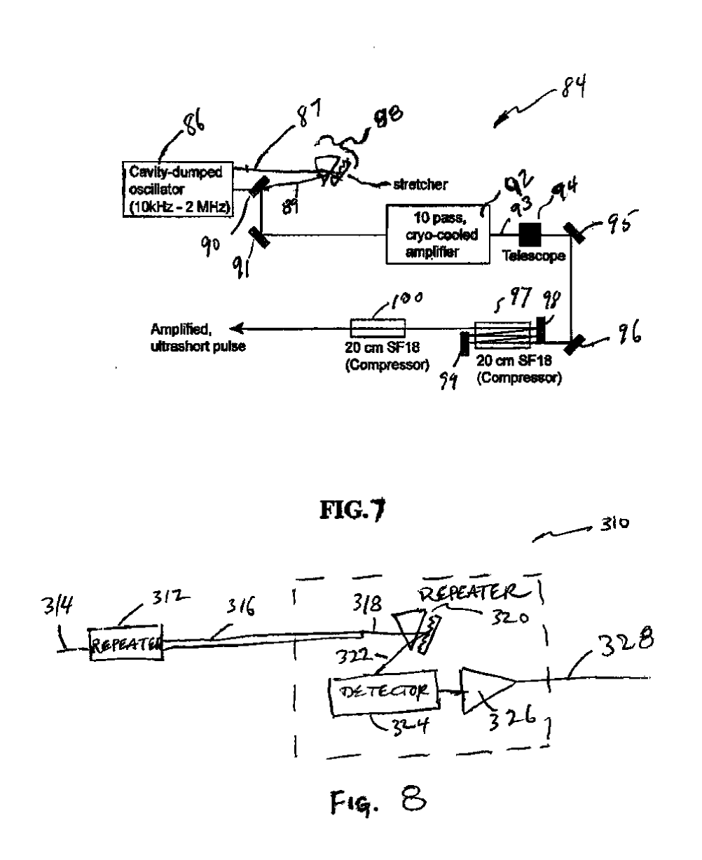

FIG. 5 shows yet another alternative embodiment of the present invention comprising a reflection grism-like device 260 which employs a common prism 262 for both input and output. A reflection grating 264 is fixed using optical cement 265 to a grating interface surface 266 of prism 262. Alternatively, one may construct the grism-like device 260 with an air space.

Prism 262 has a first surface 268 which serves as an entrance surface and a second surface 270 which is not parallel with grating 264 and which serves as an exit surface for light transmitted thought device 260.

A method for constructing a compensating grism-like device according to an illustrative embodiment of the present invention is described with reference to FIG. 6. First, the specific amount of GVD and TOD, and the relative ratio of these two parameters, must be determined at step 72. For common optical glasses at the most common short-pulse spectrum (near 800 nm wavelength), the ratio of TOD/GVD is about 0.66 fs. The designer must select a grating/prism/usage angle which will yield the determined TOD/GVD ratio. In the common example, the designer must therefore select at step 74 a grism pair with TOD and GVD with a ratio of 0.66 fs. To do this analysis, a common technique is to use optical ray tracing with a simple optimization routine.

While there are an infinite number of grating/prism/usage-angle combinations which would yield GVD and TOD with the correct ratio, it is helpful to constrain the gratings to commercially-available models at step 76, and to constrain the prism angles and materials to common catalog items at step 78. However, it should be noted that optimization of a particular design (for efficiency and compactness) may require a custom prism angle with an uncommon or exotic glass.

Inventive device can then be produced having the determined TOD/GVD ratio. The inventive devices may be designed for a cemented interface or, preferably, an air-space interface 82. Likewise, gold coated gratings are preferred. To construct the inventive device, one performs a direct cementing of the grating to the prism (standard practice in a grating replication laboratory), or constructs a fixture to rigidly hold the prism and the grating while maintaining a precise air gap (on the order of 0.5 to 2 mm).

There are an infinite number of grism designs which can be used according to various illustrative embodiments of the present invention. Table 1 lists a sample of several exemplary designs which may be employed with a prism of the type illustrated in FIGS. 3 and 4.

TABLE 1
Selected grism designs

| Grating | Prism | Prism | Incidence angle (β) | | |
|---|---|---|---|---|---|
| density | angle (α) | material | (deg)/output angle range | Cement/air? | Wavelength |
| 1480 lines/mm | 45 | BK7 | 58 | air | 770 |
| 1480 lines/mm | 60 | BK7 | 27 | air | 770 |
| 1200 lines/mm | 60 | BK7 | 15.5 | air | 770 |
| 600 lines/mm | 60 | BK7 | −7.7 | air | 770 |
| 1200 lines/mm | 45 | BK7 | 39 | air | 770 |
| 1200 lines/mm | 60 | F2 | 26.5 | air | 1030 |
| 1480 lines/mm | 60 | F2 | 45.5 | air | 1030 |
| 1740 lines/mm | 60 | SF10 | 58 | air | 1030 |
| 600 lines/mm | 26.6 | N-BAK4 | 26.6 | cement | 800 |

Referring to FIG. 6, a high-power laser system 84 using the technology of the present invention is illustrated. Seed pulses are generated by a cavity-dumped oscillator 36 which outputs a light beam 87 which is said to inventive device 88 which produces and output beam 89 having negative TOD and negative GVD and is thus temporally stretched out. Beam 89 is then sent via mirrors 90 and 91 to a ten pass amplifier 92. The amplified light 93 is then sent to a telescope 94, which functions to

The amplified life is then sent via mirrors 95 and 96 to a material compressor 97 (for example a rod of glass) which has a long equivalent optical path length, as the amplified light passes through it five times, being reflected between mirrors 98 and 99, for output through a second and final material compressor 104 final compression. Material compressors 97 and 100 have positive TOD and positive GVD.

As alluded to above, the inventive grism-like device may be used in a wide variety about locations ranging from high-powered pulse compression to any other application in which positive GVD and positive TOD must be compensated. For example, in instrumentation, pulses detected, for example, in the evaluation of a specimen by, for example, fluorescence, Raman or other analytic technique may be sent from one point to another for detection. If such optical pulses are sent on an optical fiber, the fiber will impart positive GVD and positive TOD must be compensated. Failure to do so will compromise the resolution of the system. The inventive device may be used to compensate for such positive GVD and positive TOD by applying negative GVD and negative TOD to the optical signal.

In similar fashion, in communications systems long lengths of optical fiber are used to transmit signals. As discussed above, the optical fiber used will impart distortions to the signal. Referring to FIG. 8, in a typical system 310 a repeater 312 will receive an optical signal from a fiber 314 and amplify and relay it to another length of fiber 316. In accordance of the present invention fiber 316 outputs an optical signal 318 which is sent to the inventive device 320 for application of negative GVD and negative TOD. The compensated optical signal 322 may then be sent to a detector 324 which drives an amplifier 326 coupled to another length of optical fiber 328.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A compensating grism comprising:
an entrance prism having an entrance surface and a grating interface surface;
an exit prism having a grating interface surface and an exit surface; and
a transmission grating disposed between the first prism grating interface surface and the second prism grating interface surface,
wherein said exit surface is non-parallel to said transmission grating to provide negative group velocity dispersion (−GVD) and negative third order dispersion (−TOD) of light transmitted through said grism.

2. The grism according to claim 1 wherein said light has an angle of incidence with said grating that is about equal to an angle of refraction from said grating.

3. The grism according to claim 1 wherein said light has an angle of incidence with said grating and an angle of refraction from said grating that are near Littrow.

4. The grism according to claim 1 wherein said grating has between about 300 lines per millimeter and about 2000 lines per millimeter.

5. The grism according to claim 1 wherein said light is incident with the grating at an angle below a critical angle of the prism material such that a total internal reflection of said light does not occur at a prism-grating interface.

6. A compensating grism comprising:
a prism having a first surface and a grating interface surface; and
a reflection grating disposed against the grating interface surface such that light traveling through the prism and incident to the grating reflects from the grating back into the grating interface surface,
wherein said light after reflecting from the grating exits from the prism through a surface that is non-parallel to the reflection grating to provide negative GVD and negative TOD of light transmitted through said grism.

7. A grism according to claim 6 wherein the first surface provides both an entrance surface for said light and said exit surface that is non-parallel with said grating.

8. A grism according to claim 6 wherein the first surface provides an entrance surface for said light and said prism includes a second surface which provides said exit surface that is non-parallel with the grating.

9. A grism according to claim 6:
wherein said grating has about 600 lines per millimeter; and
wherein said light has a wavelength of about 800 nanometers.

10. A grism according to claim 6:
wherein said grating is spaced from said prism.

11. A method of making a compensating grism comprising:
selecting a prism-grating pair having parameters which yield a pre-determined TOD/GVD ratio;
fixing said grating to a first prism surface of said prism such that an exit surface of the prism is not parallel to the grating.

12. The method according to claim 11 wherein said fixing comprises cementing said grating to said first surface.

13. The method according to claim 12 wherein said fixing comprises mechanically fixturing said grating relative to the first prism surface.

14. A method for making a short, high energy, high intensity laser pulse comprising:
sending a low energy pulse through a dispersive medium having a positive GVD to broaden the pulse by a factor of about between 100-10,000;
sending the broadened pulse to an amplifier wherein said amplifier adds energy to said broadened pulse;
ejecting the amplified pulse from said amplifier; and
applying the amplified pulse to an external compression grism having negative GVD and negative TOD at near Littrow angles of incidence.

15. The method according to claim 14 wherein said grism comprises:
an entrance prism having an entrance surface and a grating interface surface;
an exit prism having a grating interface surface and an exit surface; and
a transmission grating disposed between the first prism grating interface surface and the second prism grating interface surface,
wherein said exit surface is non-parallel to said transmission grating to provide negative group velocity dispersion (−GVD) and negative third order dispersion (−TOD) of light transmitted through said grism.

16. The method according to claim 14 wherein said grism comprises:
a prism having a first surface and a grating interface surface; and
a reflection grating disposed against the grating interface surface such that light traveling through the prism and incident to the grating reflects from the grating back into the grating interface surface,
wherein said light after reflecting from the grating exits from the prism through a surface that is non-parallel to the reflection grating to provide negative GVD and negative TOD of light transmitted through said grism.

17. A method for making a short high energy high intensity laser pulse comprising

18. A device comprising a transparent optical member defining an optical path and a grating positioned at a point between the beginning and end of said optical path within said transparent optical member.

19. A device as in claim 21, wherein said grating is a reflection grating and said transparent optical member is a prism and said grating is in facing relationship to one side of said prism.

20. A device is in claim 22, wherein said grating is in facing spaced relationship to one side of said prism.

21. A device as in claim 21, wherein said transparent optical member has negative GVD and negative TOD.

22. A device as in claim 24, wherein said optical path defines an input path and an output path, said input path and said output path being near Littrow.

23. A device as in claim 24, wherein said optical path defines an input path and an output path, said input path being oriented with respect to a face of said prism opposite the face which said light beam enters at an angle greater than the angle for total internal reflection.

24. A device for imparting negative TOD and negative GVD to light passing through the device, comprising:
(a) a grating; and
(b) a refractive member positioned adjacent said grating, and oriented to provide an exit light path that passes through an output face of said refractive member, where said output face is not parallel to the grating.

25. A device as in claim 27, wherein said refractive member comprises first and second refractive member portions and said grating is disposed between said first and second refractive member portions.

26. A device as in claim 27, wherein said grating is a reflective grating disposed adjacent said refractive member.

27. A device as in claim 29, wherein said grating is adhered by a transparent optical cement to said refractive member.

28. A device as in claim 29, wherein said grating is spaced from said refractive member.

29. A device as in claim 27, wherein the angle between the path for light input into the device and the path of light output from the device is between.

30. A device as in claim 27, wherein the angle between the path for light input into the device and the path of light output from the device is between.

31. A device as in claim 27, wherein the angle between the path for light input into the device and the path of light output from the device is between.

32. 3A device for imparting negative TOD and negative GVD to light passing through the device, comprising:
(a) a grating; and
(b) a refractive member positioned adjacent said grating, and oriented to provide an exit light path that passes through an output face of said refractive member, where said output face is not parallel to the grating.
